(19) United States
(12) Patent Application Publication
(10) Pub. No.: US 2015/0186569 A1
(43) Pub. Date: Jul. 2, 2015

(54) OBJECT DETECTION DEVICE, OBJECT DETECTION METHOD, AND STORAGE MEDIUM

(71) Applicant: Oki Electric Industry Co., Ltd., Tokyo (JP)

(72) Inventors: Masatoshi SEKINE, Tokyo (JP); Kurato MAENO, Tokyo (JP)

(73) Assignee: Oki Electric Industry Co., Ltd., Tokyo (JP)

(21) Appl. No.: 14/582,136

(22) Filed: Dec. 23, 2014

Related U.S. Application Data
(63) Continuation of application No. PCT/JP2013/062611, filed on Apr. 30, 2013.

(30) Foreign Application Priority Data
Jul. 2, 2012 (JP) 2012-148333

(51) Int. Cl. G06F 17/50; G06F 17/18

(52) U.S. Cl. CPC G06F 17/5009; G06F 17/18

(57) ABSTRACT

The invention provides an object detection device including a statistical model estimation section that, using a Doppler signal in a specific period of time for a given reflecting object, or using data obtained by performing a specific data conversion on the Doppler signal, estimates a statistical model expressing time series fluctuations in the Doppler signal or in the data, and a determination section that determines whether or not there is an aperiodically moving object present at the reflecting object based on incompatibility between the statistical model estimated by the statistical model estimation section and time series fluctuations in the Doppler signal or in the data.

### CROSS-REFERENCE TO RELATED APPLICATIONS

This application is a continuation application of International Application No. PCT/JP2013/062611, filed on Apr. 30, 2013, which is incorporated herein by reference in its entirety. Further, this application claims priority from Japanese Patent Application No. 2012-148333, filed on Jul. 2, 2012, the disclosure of which is incorporated by reference herein in its entirety.

### BACKGROUND OF THE INVENTION

1. Field of the Invention

The present invention relates to an object detection device, an object detection method, and a storage medium.

2. Related Art

In recent years, detection devices are appearing that utilize sensors to determine the presence or absence of aperiodically moving objects in a detection area, these being people, animals, or other objects that do not perform periodic motion. Such detection devices have diverse application to machines that switch operation according to the presence or absence of aperiodically moving objects. For example, a person detection device that determines the presence or absence of a person has diverse applications, such as application to machines that automatically switch on lights when a person is detected, or detect the presence or absence of people in a building.

From among such person detection devices, person detection devices that employ Doppler radar have advantages over person detection devices using various sensors, and are attracting attention. For example, person detection devices that use Doppler radar have the advantages of being more resilient to heat, and enabling finer movements to be detected than person detection devices using infrared sensors. Person detection devices using Doppler radar have the advantages over person detection device by image sensors of facilitating the maintenance of privacy and enabling sensing through opaque walls.

For example, such a person detection device using Doppler radar is described in “Real-time method for human presence detection by using micro-Doppler signatures information at 24 GHz” by A. V. Alejos, M. G. Sanchez, D. R. Iglesias and I Cuinas (published in IEEE Antennas and Propagation Society International Symposium (APSURSI '09), June 2009). This person detection device derives a power spectrum by short-time Fourier transformation of a signal obtained with a Doppler radar, and determines the presence or absence of a person by threshold value determination from the value of a peak in a low frequency region. Namely, this person detection device determines the presence or absence of a person by the simple magnitude of frequency components.

However, signals obtained from Doppler radars may contain frequency components arising from a periodically moving object reflecting electromagnetic waves, and discrimination therefore cannot be made as to whether or not a given frequency component arises from an aperiodically moving object or arises from another periodically moving object. Accordingly, mis-determination of the presence or absence of an aperiodically moving object can arise due to disturbance by periodically moving objects that reflect electromagnetic waves. For example, in such a method, there is the possibility of mis-determination of the presence or absence of a person due to disturbance by machines, equipment or other objects with operating speeds that resemble actions such as walking or arm swinging, or activity such as breathing or involuntary body swaying of a person.

### SUMMARY

In consideration of the above circumstances, the present invention provides a novel and improved object detection device, object detection method, and non-transitory storage medium capable of determining the presence or absence of an aperiodically moving object even in cases in which disturbance is present in the detection area of a Doppler signal.

An aspect of the present invention provides an object detection device including a statistical model estimation section that is configured, using a Doppler signal in a specific period of time for a given reflecting object, or using data obtained by performing a specific data conversion on the Doppler signal, to estimate a statistical model expressing time series fluctuations in the Doppler signal or in the data; and a determination section that is configured to determine whether or not there is an aperiodically moving object present at the reflecting object based on incompatibility between the statistical model estimated by the statistical model estimation section and the time series fluctuations in the Doppler signal or in the data.

The statistical model estimation section may assume that motion of a reflecting object is a periodic motion, and may estimate a statistical model according to the periodic motion.

The determination section may be configured to determine the presence of the aperiodically moving object at the reflecting object in a case in which a degree of incompatibility of the statistical model estimated by the statistical model estimation section exceeds a specific threshold value.

The statistical model estimation section may be configured to re-estimate the statistical model and update the statistical model in a case in which the degree of incompatibility of the statistical model exceeds a specific threshold value.

The case in which the degree of incompatibility of the statistical model exceeds the specific threshold value may include a case in which the degree of incompatibility of the statistical model exceeds the threshold value for a specific period of time or greater.

The case in which the degree of incompatibility of the statistical model exceeds the specific threshold value may include a case in which the degree of incompatibility of the statistical model exceeds the threshold value for a specific proportion or greater in a specific period of time.

The model estimation section may be configured to estimate the statistical model and update the statistical model at specific intervals.

The statistical model estimation section may be configured to estimate a coefficient contained in the statistical model.

The degree of incompatibility of the statistical model may be a numerical value computed based on Akaike's information criterion (AIC) of the statistical model, or may be a difference between a predicted value of the statistical model and an actual value.

The degree of incompatibility of the statistical model may be a statistical quantity computed from the numerical value at specific intervals.

The statistical model may be: an autoregressive model (AR model), an autoregressive moving average model (ARMA model), an autoregressive integrated moving average model (AMNIA), or an autoregressive and moving average processes with exogenous regressors model (ARIMAX model), or may be multivariate models thereof: a vector autoregressive model (VAR model), a vector autoregressive moving average model (VARMA model), a vector autoregressive integrated moving average model (VARIMA model), or a vector autoregressive and moving average processes with exogenous regressors model (VARIMAX model).

The data obtained by performing the specific data conversion on the Doppler signal may include an instantaneous amplitude, an instantaneous frequency, or an areal velocity computed from the Doppler signal.

The aperiodically moving object may be a person.

Another aspect of the present invention provides an object detection method including: using a Doppler signal in a specific period of time for a given reflecting object, or using data obtained by performing a specific data conversion on the Doppler signal, to estimate a statistical model expressing time series fluctuations in the Doppler signal or in the data; and determining whether or not there is an aperiodically moving object present at the reflecting object based on incompatibility between the statistical model and time series fluctuations in the Doppler signal or in the data.

Yet another aspect of the present invention provides a non-transitory computer readable storage medium storing a program that causes a computer to execute object detection processing, the object detection processing including: using a Doppler signal in a specific period of time for a given reflecting object, or using data obtained by performing a specific data conversion on the Doppler signal, to estimate a statistical model expressing time series fluctuations in the Doppler signal or in the data; and determining whether or not there is an aperiodically moving object present at the reflecting object based on incompatibility between the statistical model and time series fluctuations in the Doppler signal or in the data.

As explained above, the above aspects enable determination of the presence or absence of an aperiodically moving object even in cases in which disturbance is present in the detection area of a Doppler signal.

### BRIEF DESCRIPTION OF THE DRAWINGS

FIG. 1 is an explanatory diagram illustrating a configuration of a person detection device according to an exemplary embodiment.

FIG. 2 is a schematic diagram of internal configuration of a person detection device according to an exemplary embodiment.

FIG. 3 is a functional block diagram of a person detection signal processing section.

FIG. 4 is a flowchart illustrating determination processing of a person detection device according to an exemplary embodiment.

FIG. 5 is a graph illustrating an example of prediction error in a statistical model estimated for a periodic signal.

FIG. 6 is a graph illustrating an example of prediction error in a statistical model estimated for an aperiodic signal.

FIG. 7 is a waveform plot of low frequency components of a Doppler signal for a case in which a reflecting object is a fan that repeatedly performs a swinging movement with a cycle of approximately 15 seconds.

FIG. 8 is a waveform plot of low frequency components of a Doppler signal for a case in which a reflecting object is a person.

FIG. 9 is a graph illustrating change in prediction error accompanying change in an operation pattern of a periodically moving object.

FIG. 10 is a graph illustrating change in prediction error accompanying change in an operation pattern of a periodically moving object for a case in which a statistical model coefficient estimation period is provided.

FIG. 11 is a graph illustrating change in prediction error accompanying entry of a person for a case in which a statistical model coefficient estimation period is provided.

### DETAILED DESCRIPTION

Detailed explanation follows regarding exemplary embodiments, with reference to the accompanying drawings. In the present specification and drawings, configuration elements having substantially the same functional configuration are appended with the same reference numeral, and duplicate explanation thereof will be omitted.

### 1. BASIC CONFIGURATION OF OBJECT DETECTION DEVICE

The present invention may be implemented in various embodiments, as explained in detail, for example, under 3. Exemplary Embodiments. An object detection device according to an exemplary embodiment (person detection device 20) includes:

A. a statistical model estimation section that, using a Doppler signal in a specific period of time for a given reflecting object, or using data obtained by performing a specific data conversion on the Doppler signal, estimates a statistical model expressing time series fluctuations in the Doppler signal or in the data; and

B. a determination section that determines whether or not there is an aperiodically moving object present at the reflecting object based on incompatibility between the statistical model estimated by the statistical model estimation section and time series fluctuations in the Doppler signal or the data.

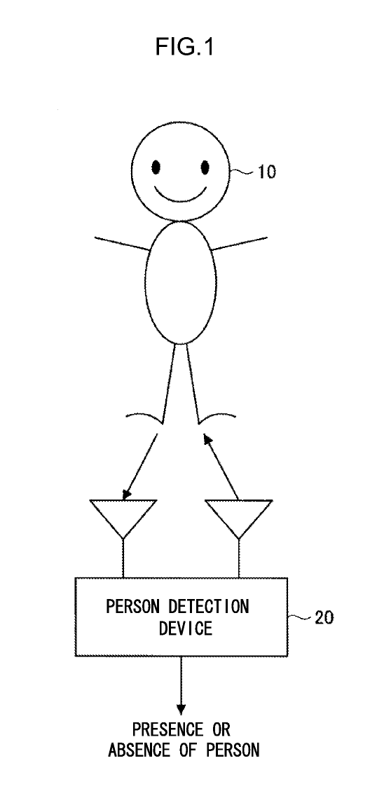

Explanation first follows regarding a basic configuration of such a person detection device 20 with reference to FIG. 1.

FIG. 1 is an explanatory diagram illustrating a configuration of the person detection device 20 according to an exemplary embodiment. As illustrated in FIG. 1, the person detection device 20 detects the presence or absence of a person 10.

The person 10 is a reflecting object that reflects electromagnetic waves or ultrasound emitted from a Doppler radar. There may be plural persons 10 present. The subject for presence or absence determination by the person detection device 20 is not limited to the person 10, and the subject may be an animal or other aperiodically moving object. The person detection device 20 detects whether or not there is a person 10, an animal or another aperiodically moving object present at a reflecting object, namely detects the presence or absence of an aperiodically moving object, using a Doppler signal that is a signal with the frequency of the difference between electromagnetic waves emitted by a Doppler radar and electromagnetic waves reflected by the reflecting object present in the detection area.

The present exemplary embodiment relates to the person detection device 20, and more particularly to determination processing that determines the presence or absence of the person 10. Explanation follows regarding the determination processing of the presence or absence of the person 10 by an object detection device of a Comparative Example, followed by detailed explanation regarding the present exemplary embodiment.

### 2. OBJECT DETECTION DEVICE OF COMPARATIVE EXAMPLE

In a person detection device of a Comparative Example, first a power spectrum is obtained by short-time Fourier transformation of a Doppler signal. Then the person detection device of the Comparative Example determines that there is a person 10 present when a peak value in a specific frequency region of the obtained power spectrum is higher than a threshold value.

Summary of Issues

In the person detection device of the Comparative Example, determination of the presence or absence of the person 10 is made by deriving a power spectrum from the Doppler signal and making threshold determination on the peak value of the specific frequency region. However, such a method is not able to discriminate as to whether or not a given frequency component arises from a person 10 or arises from other aperiodically moving object.

For example, operations at speeds that resemble actions such as walking or arm swinging, or activity such as breathing or involuntary body swaying of the person 10, include the swinging of a fan or heater, a turntable of a microwave, and operation of a washing machine. There is the possibility that the power spectrum of such operations that resemble the person 10 arises in a frequency region resembling a power spectrum obtained by the person 10. The person detection device of the Comparative Example finds discrimination between the person 10 and a periodically moving object, and determination the presence or absence of the person 10, difficult when using the values of the power spectrum of the frequency region alone, in cases in which there is disruption due to such periodically moving objects.

An example of another method to discriminate between the person 10 and a periodically moving object, is a method that applies an autocorrelation function to time series fluctuations in a Doppler signal to determine the periodicity of the Doppler signal. However, in the methods that determine the periodicity of a Doppler signal using an autocorrelation function, for example, detecting the aperiodic signal isi difficult in cases in which an aperiodic signal of small amplitude is superimposed on a periodic signal of large amplitude, i.e., the determination results depend on the amplitude of both components. Moreover, there is no recognition of the issue of how to discriminate between the person 10 and other object in cases in which other object is present that performs movement with speed resembling the action and the activity of the person 10, and no solution is reached.

### 3. EXEMPLARY EMBODIMENT

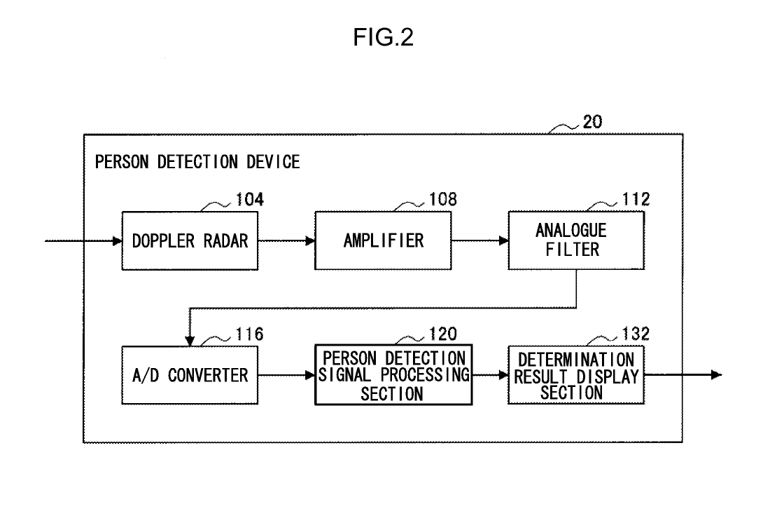

Explanation follows regarding an exemplary embodiment, with reference to FIG. 2 to FIG. 10. The present exemplary embodiment enables determination of the presence or absence of an aperiodically moving object even in cases in which disturbance is present in the detection area of the Doppler signal.

Configuration

FIG. 2 is a schematic diagram of an internal configuration of a person detection device 20 according to the exemplary embodiment. As illustrated in FIG. 2, the person detection device 20 includes a Doppler radar 104, an amplifier 108, an analogue filter 112, an A/D converter 116, a person detection signal processing section 120, and a determination result display section 132.

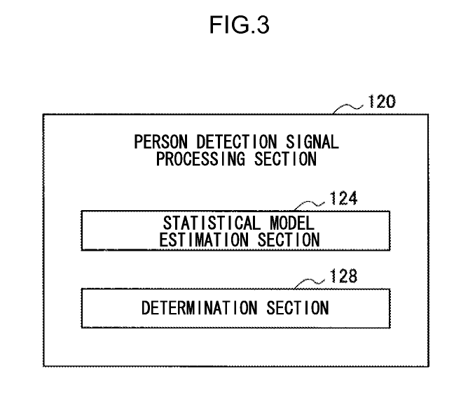

FIG. 3 is a functional block diagram of a person detection signal processing section 120. As illustrated in FIG. 3, the person detection signal processing section 120 includes a statistical model estimation section 124, and a determination section 128.

The Doppler radar 104 emits and receives electromagnetic waves or ultrasound to, and from, a given reflecting object, such as an aperiodically moving object or a periodically moving object, and outputs a Doppler signal that is a signal with the frequency of the difference between the emitted electromagnetic waves or ultrasound and the received electromagnetic waves or ultrasound. The amplifier 108 amplifies the Doppler signal output from the Doppler radar 104. The analogue filter 112 raises the signal quality in the Doppler signal output by the amplifier 108, by cutting out noise such as power supply noise, suppressing aliasing, and the like, and acquires and outputs the relevant frequency components thereof.

The A/D converter 116 converts the Doppler signal from an analogue signal output from the analogue filter 112 to a digital signal, and outputs the digital signal. The person detection signal processing section 120 processes the digitalized Doppler signal output by the A/D converter 116, and determines the presence or absence of a person 10. More precisely, using the Doppler signal of a specific period of time, or using data obtained by performing specific data conversion on the Doppler signal, the statistical model estimation section 124 estimates a statistical model expressing time series fluctuations in the Doppler signal or in the data. The determination section 128 determines whether or not the person 10 is present at the reflecting object, namely the presence or absence of the person 10, using the statistical model estimated by the statistical model estimation section. The person detection signal processing section 120 processes the Doppler signal in the specific period of time and, therefore, may include a function to accumulate the Doppler signal. Alternatively, for example, a logger or a computer that store various data may accumulate the Doppler signal. The person detection signal processing section 120 may include a function that cuts out noise in the digital signal, serving as a digital filter. The determination result display section 132 is a display section that displays the determination result by the person detection signal processing section 120.

In FIG. 2, the Doppler radar 104, the amplifier 108, the analogue filter 112, the A/D converter 116, the person detection signal processing section 120, and the determination result display section 132 are illustrated connected together within the person detection device 20; however, the exemplary embodiment is not limited to this example. The respective configuration elements may be separate machines from each other, or, for example, the amplifier 108, the analogue filter 112, the A/D converter 116, and the person detection signal processing section 120 may be included in a computer, and the determination result display section 132 may be implemented by a display.

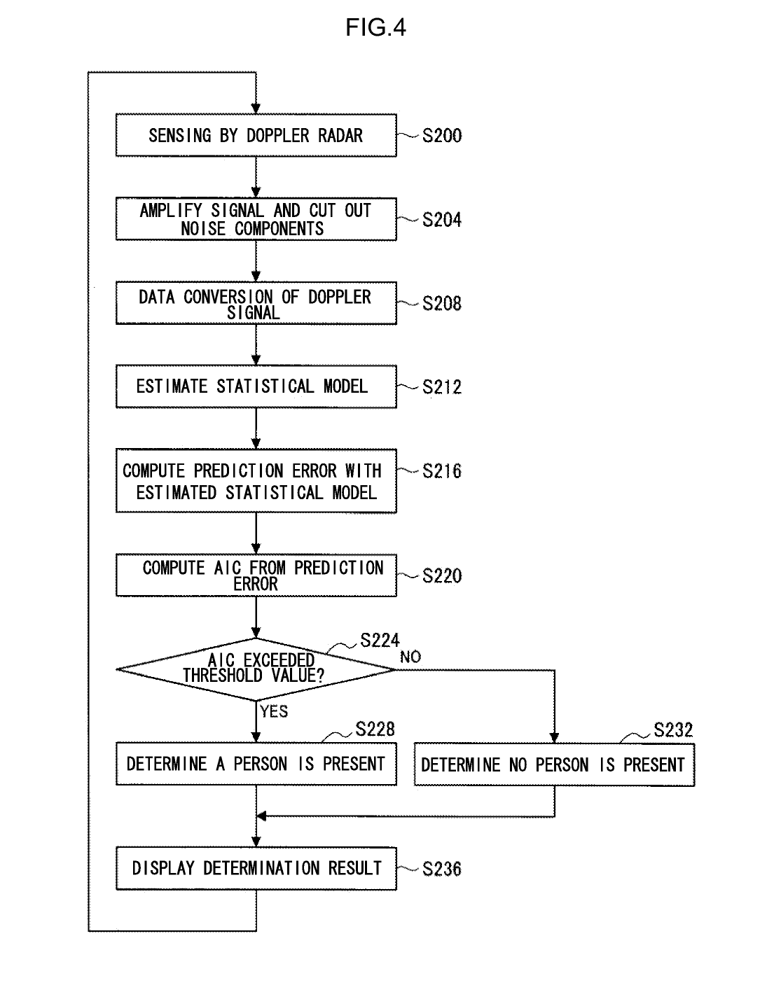

The configuration of the person detection device 20 has been explained above. The present exemplary embodiment relates to the above person detection device 20, and in particular relates to detection processing by the person detection signal processing section 120. Accordingly, detailed explanation follows regarding operation of the person detection signal processing section 120, with reference to FIG. 4 to FIG. 10.

Operation

The operation of the person detection device 20 is classified into 3 stages, 3-1: Acquisition and Data Conversion of Doppler Signal, 3-2: Estimation of Statistical Model, and 3-3: Determination of Presence or Absence of a Person. Explanation follows regarding the operation at each stage, with reference to FIG. 4.

FIG. 4 is a flowchart of determination processing of the person detection device 20 according to the exemplary embodiment.

3-1: Acquisition and Data Conversion of Doppler Signal

First, at step S200, the Doppler radar 104 senses, by emitting electromagnetic waves or ultrasound, and receiving electromagnetic waves or ultrasound reflected by a reflecting object. The Doppler radar 104 outputs a Doppler signal that is a signal with the frequency of the difference between the emitted electromagnetic waves or ultrasound and the received electromagnetic waves or ultrasound reflected by the reflecting object.

Then at step S204, the amplifier 108 amplifies the Doppler signal output by the Doppler radar 104, and then the analogue filter 112 cuts out noise components. Detailed description follows regarding the processing at step S204.

Due to the analogue signal obtained by the Doppler radar 104 generally being a weak signal, the amplifier 108 amplifies the analogue signal in order to improve the signal-noise ratio (S/N ratio).

The Doppler signal obtained when the reflecting object is the person 10 includes various frequency components from low frequencies to high frequencies. The Doppler signal includes many low frequency components that include frequencies of breathing and pulse when walking and when stationary, involuntary swaying of the body, and the like. However, in a Doppler signal observed when the reflecting object is, for example, a fan, components in the Doppler signal arising for example from rotation operation of the fan, may either have a fixed frequency, or are distributed in a limited frequency band. The effects of frequencies of Doppler signals observed by operation of such a machine have little overlap with the frequencies of Doppler signals observed due to movement of the person 10, and can be separated as noise by band-pass filtering or the like. In an analogue signal, such noise is cut out by, for example, the analogue filter 112, and in the digital signal converted by the A/D converter 116, such noise is cut out by digital filtering in the person detection signal processing section 120.

Then at step S208, the statistical model estimation section 124 performs specific data conversion on the Doppler signal output by the A/D converter 116. Detailed description follows regarding processing at step S208.

The Doppler radar 104 outputs, as a Doppler signal, an IQ signal with a phase difference of ±90° due to movement of the reflecting object towards, or away from, the Doppler radar 104. The IQ signal is a complex signal formed from signals of 2 channels: an I signal representing an in-phase signal, and a Q signal representing a quadrature signal. By data conversion of the IQ signal, the statistical model estimation section 124 is capable of obtaining not only the waveform of an envelope of the amplitude of the signals of the two channels, and the speed of the reflecting object, but also data of the movement direction of the reflecting object. The determination section 128 is then able to determine the presence or absence of the person 10 by using such converted data. When the reflecting object is approaching the Doppler radar 104, the I signal leads the Q signal by 90°, and when the reflecting object is retreating from the Doppler radar 104, the I signal lags the Q signal by 90°. As well as data converted by the statistical model estimation section 124, the determination section 128 is also capable of determining the presence or absence of the person 10 using the IQ signal without data conversion.

As an example of data conversion, an example is given below in which the statistical model estimation section 124 performs data conversion of the IQ signal into an instantaneous amplitude, an instantaneous frequency, and an areal velocity. The instantaneous frequency is proportional to the velocity of the reflecting object. In cases in which a signal is sampled at a sampling frequency fₛ, the sampling interval Δt is 1/fₛ. The instantaneous amplitude Aₙ, the instantaneous frequency Fₙ, and the areal velocity Sₙ are respectively expressed by the following Equations, wherein Iₙ and Qₙ are the respective waveforms of the n^{th} sample of the IQ signal.

$$\begin{matrix} {A}_{n} = \sqrt{{I}_{n}^{2} + {Q}_{n}^{2}} & Equation ( 1 ) \\ {F}_{n} = \frac{1}{2 π} \frac{{θ}_{n + 1} - {θ}_{n}}{Δ t} = \frac{{f}_{s}}{2 π} ( arctan ( {Q}_{n + 1} \text{/} {I}_{n + 1} ) - arctan ( {Q}_{n} \text{/} {I}_{n} ) ) & Equation ( 2 ) \\ {S}_{n} = \frac{1}{2} {A}_{n}^{2} sin ( {θ}_{n + 1} - {θ}_{n} ) = \frac{1}{2} ( {I}_{n}^{2} + {Q}_{n}^{2} ) sin ( arctan ( {Q}_{n + 1} \text{/} {I}_{n + 1} ) - arctan ( {Q}_{n} \text{/} {I}_{n} ) ) & Equation ( 3 )\end{matrix}$$

Wherein θₙ is the instantaneous phase.

3-2: Estimation of Statistical Model

Explanation has been given above regarding acquisition and data conversion processing of the Doppler signal. Explanation next follows regarding estimation processing of the statistical model from the acquired Doppler signal or data obtained by data conversion.

The statistical model estimation section 124 assumes the motion of the reflecting object is a periodic motion, and estimates a statistical model corresponding to the periodic motion. Specifically, at step S212, the statistical model estimation section 124 assumes that time series fluctuations in the acquired Doppler signal, or in data obtained by performing data conversion thereon, will periodically fluctuate, and estimates statistical model coefficients to the order M from time series data in a given observation period T. Detailed description follows regarding processing at step S212.

Examples of statistical models for performing linear prediction on time series data that may be utilized in the present exemplary embodiment include, for example, autoregressive models (AR models), autoregressive moving average models (ARMA models), autoregressive integrated moving average models (ARIMA), and autoregressive and moving average processes with exogenous regressors models (ARIMAX models). There are also, in addition, expanded multivariate versions thereof, such as vector autoregressive models (VAR models), vector autoregressive moving average models (VARMA models), vector autoregressive integrated moving average models (VARIMA models), and vector autoregressive and moving average processes with exogenous regressors models (VARIMAX models). When using a univariate model, such as an AR model or an ARMA model as the statistical model, the statistical model estimation section 124 estimates a statistical model for one set of time series data out of the I signal, the Q signal, or the data obtained by the above-described conversion. However, when using a multivariate model, such as a VAR model or a VARMA model as the statistical model, the statistical model estimation section 124 estimates a statistical model for plural sets of time series data out of the I signal, the Q signal, or the data obtained by the above-described conversion. In the following, explanation is given, as an example, of determination processing using an autoregressive moving average model (ARMA model).

The ARMA model consists of an autoregressive (AR) component and a moving average (MA) component. An ARMA model is expressed in the following manner for given time series data xₙ, wherein p is the order of an autoregressive coefficient aᵢ, q is the order of a moving average coefficient bⱼ, and eₙ is prediction error.

$${x}_{n} + {\sum }_{i = 1}^{p} {a}_{i} {x}_{n - i} = {\sum }_{j = 1}^{q} {b}_{j} {e}_{n - j} + {e}_{n} \qquad Equation ( 4 )$$

The prediction error represents the difference between the predicted value predicted by the ARMA model, and the actual measurement value that is actually measured. The instantaneous amplitude Aₙ, the instantaneous frequency Fₙ, or the areal velocity Sₙ as shown in Equations (1) to (3), other time series data converted from the IQ signal, or the I signal or the Q signal may be used as the time series data xₙ. For example, if the time series data xₙ is an instantaneous amplitude of the reflecting object, the prediction error is the difference between the instantaneous amplitude predicted by the ARMA model, and the instantaneous amplitude that is actually measured.

The statistical model estimation section 124 then employs Prony's method to derive autoregressive coefficients a and moving average coefficients b. In Prony's method, first the statistical model estimation section 124 models time series data xₙ as an AR process, as expressed below.

$$( 1 + {\sum }_{i = 1}^{∞} {α}_{i} {z}^{i} ) {x}_{n} = {e}_{n} \qquad Equation ( 5 )$$

The statistical model estimation section 124 then derives an impulse response xₙ as expressed below.

$${x}_{n} = ( 1 + {\sum }_{i = 1}^{∞} {β}_{k} {z}^{k} ) {e}_{n} \qquad Equation ( 6 )$$

Wherein α and β are coefficients in the AR process.

In the above AR process, if an impulse response is taken as corresponding to an ARMA model with coefficients (p, q), then the ARMA model is expressed as follows.

$${x}_{n} = \frac{( 1 + {\sum }_{j = 1}^{q} {b}_{j} {z}^{j} )}{( 1 + {\sum }_{i = 1}^{p} {a}_{i} {z}^{i} )} {e}_{n} \qquad Equation ( 7 )$$

If M is a sufficiently large value, then the ARMA model can be approximated as follows.

$$( 1 + {\sum }_{k = 1}^{M} {β}_{k} {z}^{k} ) ( 1 + {\sum }_{i = 1}^{p} {a}_{i} {z}^{i} ) = ( 1 + {\sum }_{j = 1}^{q} {b}_{j} {z}^{j} ) \qquad Equation ( 8 )$$

Comparing terms in which z has the same exponent for p≧q enables the statistical model estimation section 124 to derive ARMA coefficients by solving the following formula.

$$[ \begin{matrix}1 & & & & & & & & \\ {β}_{1} & 1 & & & & & & & \\ {β}_{2} & {β}_{1} & 1 & & & & & & \\ ⋮ & ⋮ & & ⋱ & & & & & \\ {β}_{q} & {β}_{q - 1} & … & {β}_{1} & 1 & & & & \\ {β}_{q + 1} & {β}_{q} & … & … & {β}_{1} & 1 & & & \\ ⋮ & & & & & ⋱ & ⋱ & & \\ {β}_{p} & {β}_{p - 1} & … & … & … & … & {β}_{1} & & 1 \\ ⋮ & ⋮ & & & & & & & ⋮ \\ {β}_{p + q} & {β}_{p + q + 1} & & & … & & & & {β}_{q} \\ ⋮ & & & & & & & & ⋮ \\ {β}_{M} & & & & … & & & & {β}_{M - p}\end{matrix} ] [ \begin{matrix}1 \\ {a}_{1} \\ {a}_{2} \\ ⋮ \\ {a}_{q} \\ {a}_{q + 1} \\ ⋮ \\ {a}_{p}\end{matrix} ] = [ \begin{matrix}1 \\ {b}_{1} \\ {b}_{2} \\ ⋮ \\ {a}_{q}\end{matrix} ] \qquad Equation ( 9 )$$

The statistical model estimation section 124 obtains the autoregressive coefficients a, by solving the terms from the (q+1)^{th} to the M^{th} terms that do not depend on the moving average coefficients bⱼ in Equation (9). The statistical model estimation section 124 then obtains moving average coefficients bⱼ by substituting autoregressive coefficients aᵢ into the terms from the 1^{st} term to the q^{th} term in Equation (9).

When the ARMA model is as set out above, taking \tilde{x}ₙ as the left side of Equation (4) enables covariance function \tilde{r}₀ for timing 0 of \tilde{x}ₙ to be expressed as follows:

$${\tilde{r}}_{0} = E [ {( {x}_{n} + {\sum }_{i = 1}^{p} {a}_{i} {x}_{n - i} )}^{2} ] = E [ {( {e}_{n} + {\sum }_{j = 1}^{q} {b}_{j} {e}_{n - j} )}^{2} ] = {\hat{σ}}_{e}^{2} {\sum }_{j = 0}^{q} {b}_{j}^{2} \qquad Equation ( 10 )$$

The statistical model estimation section 124 accordingly computes the prediction error variance \tilde{σ}ₑ² of the ARMA model according to the following equation, wherein N is the number of data samples.

$${\hat{σ}}_{e}^{2} = \frac{{\tilde{r}}_{0}}{{\sum }_{j = 0}^{q} {b}_{j}^{2}} = \frac{\frac{1}{N - p} {\sum }_{n = p + 1}^{N} {( {x}_{n} + {\sum }_{i = 1}^{p} {a}_{i} {x}_{n - i} )}^{2}}{( 1 + {\sum }_{j = 1}^{q} {b}_{j}^{2} )} \qquad Equation ( 11 )$$

The degree of misfit of the statistical model estimated in the above manner to the time series fluctuations in the data is defined in the present exemplary embodiment as the degree of incompatibility of the statistical model. The smaller the degree of incompatibility of the statistical model, the better the fit to the time series fluctuations of the data. In contrast, the larger the degree of incompatibility of the statistical model, the worse the fit to the time series fluctuations of the data. When the statistical model is fitted to a given signal, an error generally arises between the estimated values from the statistical model, and the actual values that is actually measured. Thus, for example, such a prediction error that is the difference between the estimated values and the actually measured values can be used as the degree of incompatibility of the statistical model. Another example of the degree of incompatibility of the statistical model is the Akaike's information criterion (AIC) expressed by Equation (12) below. AIC is an evaluation measure representing the goodness of fit to the statistical model. An example is described below in which AIC is used as the degree of incompatibility of the statistical model in the present exemplary embodiment, but final prediction error (FPE) or any other evaluation measure may also be used. Explanation first follows regarding an example in which prediction error is used as the degree of incompatibility of the statistical model.

When the Doppler radar 104 observes movement of a periodically moving object such as a machine, a signal arises in which the value of the AR coefficient of time series data xₙ does not vary with time, or varies with a fixed cycle. As a result, a model constructed with an AR coefficient derived from a given time band gives a good fit to time series data of other time bands when constructed with the same value of AR coefficient, and the prediction error is small. However, when the Doppler radar 104 observes aperiodic motion such as movement of the person 10, the value of the AR coefficient of time series data xₙ is a value that varies aperiodically with time. As a result, a model constructed with an AR coefficient derived for a given time band is a model unique to that time band, with poor fit to time series data for other times, and there is a large prediction error as a result. Namely, the magnitude of the prediction error depends on the magnitude of non-periodicity in the time series signal.

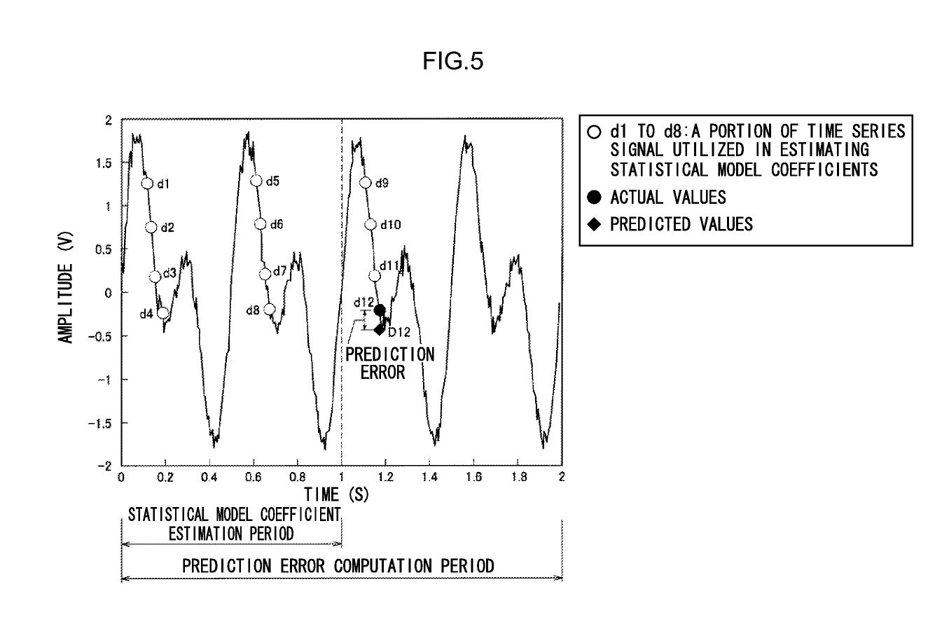

Explanation follows with reference to FIG. 5, regarding the prediction error for cases in which reflecting objects do not include the person 10, which is an aperiodically moving object; namely, when the Doppler signal is a periodic signal that fluctuates periodically.

FIG. 5 is a graph illustrating an example of prediction error for a statistical model estimated for a periodic signal. As illustrated in FIG. 5, the statistical model estimation section 124 first assumes that the signal is a periodic signal in a statistical model coefficient estimation period, and estimates coefficients of a statistical model to express the periodic fluctuations. The statistical model estimation section 124 then uses the coefficients of the estimated statistical model to estimate signal values for future times from past signal values.

When the signal is indeed a periodic signal, then the past signal values have a substantially fixed characteristic relationship with the next predicted signal values. For example, the next signal value observed after d₁, d₂, and d₃ is d₄, and the next signal value after d₅, d₆, and d₇ is d₈. Thus the next signal after a signal of a similar time series has a similar value. Therefore, when the statistical model estimation section 124 uses the coefficients for the statistical model estimated according to the periodicity of the periodic signal, the prediction error in the prediction error computation period is small. For example, based on signal values d₉, d₁₀, d₁₁ that are similar to the signal values d₅, d₆, and d₇ measured during the statistical model estimation period, a predicted value D₁₂ predicted by the statistical model estimation section 124 is close to a signal value d₁₂ actually observed.

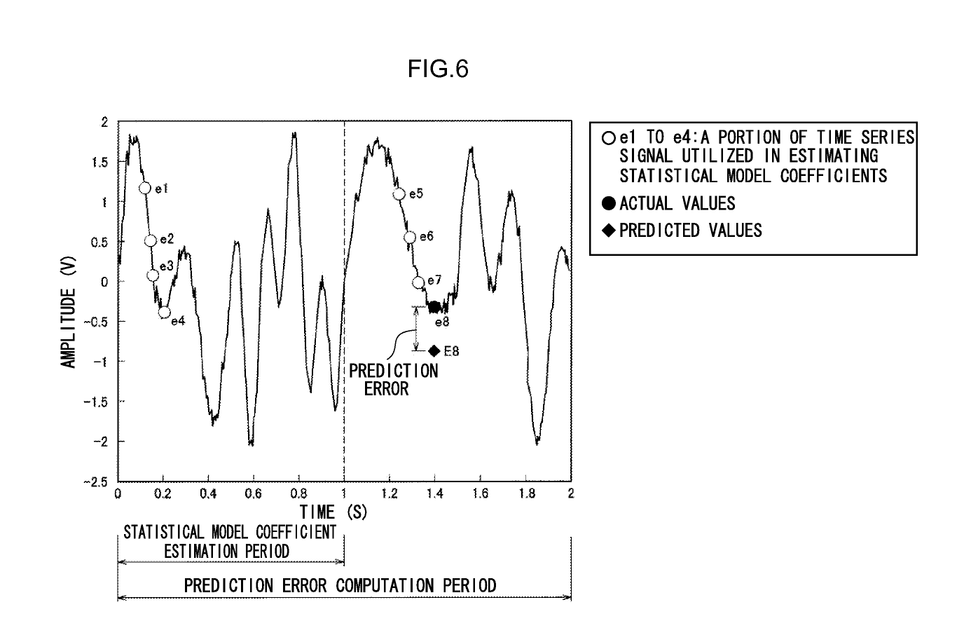

However, when the person 10, which is an aperiodically moving object, is included amongst the reflecting objects, namely when the Doppler signal is an aperiodic signal that fluctuates aperiodically, the prediction error is larger than that of a periodic signal. Explanation follows regarding prediction error when the Doppler signal is an aperiodic signal that fluctuates aperiodically, with reference to FIG. 6.

FIG. 6 is a graph illustrating an example of prediction error for a statistical model estimated for an aperiodic signal. As illustrated in FIG. 6, similarly to in the processing explained with reference to FIG. 5, the statistical model estimation section 124 assumes that the Doppler signal is a periodic signal, estimates the coefficients of the statistical model, and estimates the next signal value from past signal values.

When the signal is actually an aperiodic signal, there is not a substantially fixed characteristic relationship between the past signal values and the next signal value to be measured. For example, no other series of signal values appears that is similar to the signal values e₁, e₂, e₃, and e₄ measured during the statistical model estimation period. The signal values e₅, e₆, and e₇ are different from the signal values e₁, e₂, and e₃, and e₈ that is the next signal value observed after the signal values e₅, e₆, and e₇ is also different from e₄ that is the next signal value observed after the signal values e₁, e₂, and e₃. There is accordingly a large prediction error between the predicted value E₈ estimated from the statistical model on the assumption of a periodic signal and the actual signal value e₈.

Thus, the magnitude of the prediction error depends on whether or not the Doppler signal is an aperiodic signal, namely whether or not the person 10, an aperiodically moving object, is included amongst the reflecting objects.

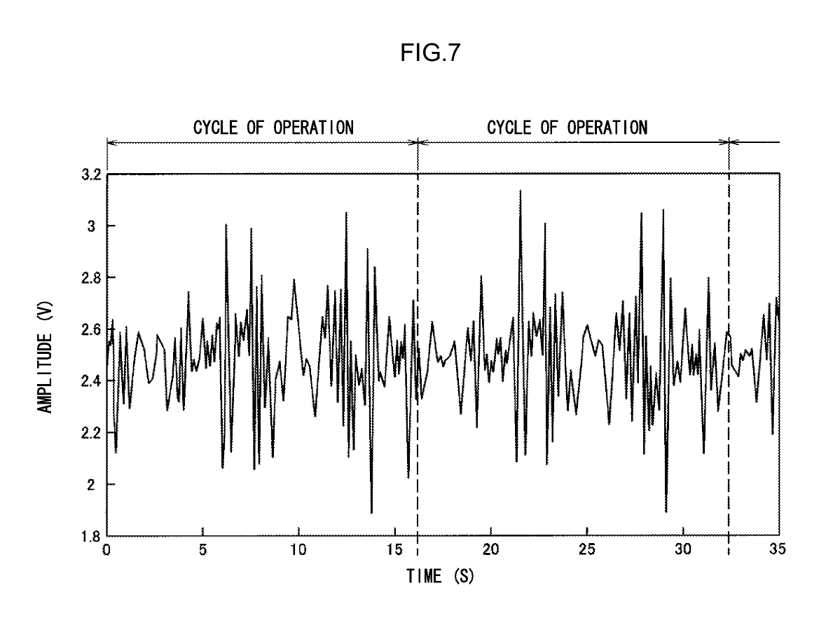

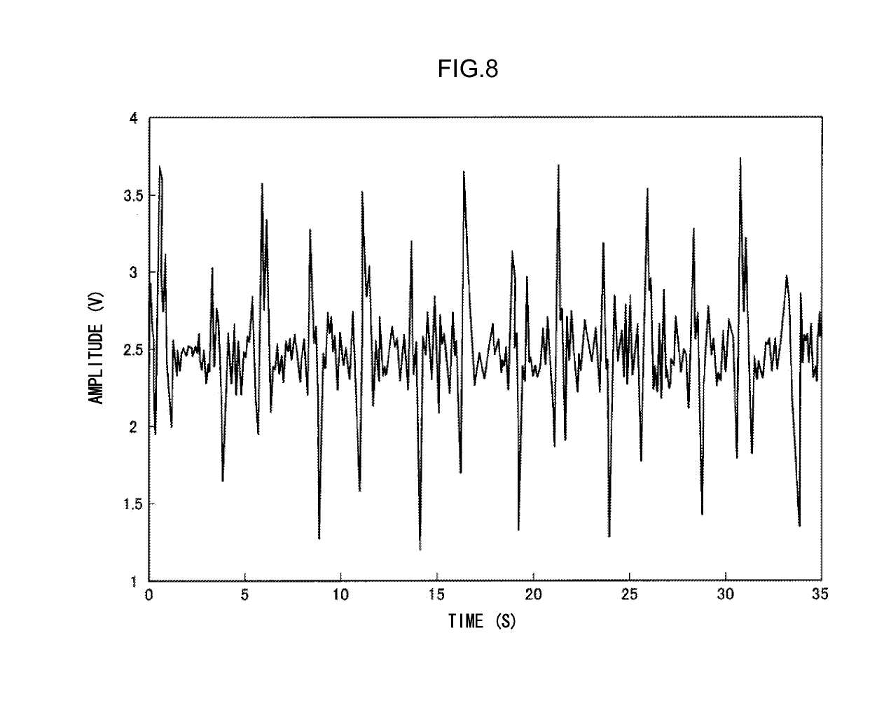

Explanation next follows regarding a Doppler signal for a case in which a fan with a swing operation is the reflecting object as an example of a periodically moving object performing a movement with a speed that resembles the actions and activity of the person 10, with reference to FIG. 7, and then explanation follows regarding a Doppler signal for a case in which the reflecting object is the person 10, with reference to FIG. 8.

FIG. 7 is a waveform plot of low frequency components of a Doppler signal in a case in which the reflecting object is a fan that repeatedly performs a swing operation with a cycle of approximately 15 seconds. The Doppler signal illustrated in FIG. 7 is a signal from which the frequency region of 5 Hz and above has been cut out by the analogue filter 112 or by a digital filter in the statistical model estimation section 124, eliminating effects from the rotation operation of the blades of the fan. As illustrated in FIG. 7, the waveform depends on the swing operation that is a periodic movement, and so the Doppler signal is a signal that is periodic according to the swinging. The swing operation repeats the same operation with a cycle of approximately 15 seconds, and so the observed waveform is also a periodic signal with the same waveform repeating at a cycle of approximately 15 seconds.

FIG. 8 is a waveform plot of low frequency components of a Doppler signal for a case in which the reflecting object is the person 10. Similarly to in FIG. 7, the signal has had the frequency region of 5 Hz and above cut out by the analogue filter 112 or by a digital filter in the statistical model estimation section 124. As illustrated in FIG. 8, since the movement of the person 10 fluctuates aperiodically, the waveform of the Doppler signal either has no fixed cycle, or does not maintain a cycle. Thus, even though the statistical model estimation section 124 estimates a statistical model expressing periodic fluctuations on the assumption that the Doppler signal is a periodic signal, a large prediction error arises due to the signal not being a periodic signal.

The magnitude of the degree of incompatibility of the statistical model accordingly depends on whether the Doppler signal is a periodic signal or an aperiodic signal. Namely, the degree of incompatibility of the statistical model is small when the reflecting object is a periodically moving object, and the degree of incompatibility of the statistical model is large when the reflecting object is the person 10.

As described in detail above, at step S212, the statistical model estimation section 124 estimates the statistical model coefficients of order M from time series fluctuations in the Doppler signal obtained at the observation period T, or data obtained by data conversion thereon. The order M of the statistical model may be a particular given value. The model is generally overly simplistic when the order M is excessively small, and as a result the prediction error is increased. However, the model is over complicated when the order M of the statistical model is excessively large, and as a result the degree of incompatibility with an unknown sample is increased. The order M may accordingly be a value that minimizes AIC as expressed by Equation (12) below. Or, at step S212, rather than taking a particular value for the order M, the statistical model estimation section 124 may estimate the order M to minimize the AIC, and may then estimate the statistical model of the estimated order M.

Generally, the computation volume to derive the statistical model coefficients such as that expressed by Equation (9) increases for cases in which the statistical model coefficient estimation period is a high proportion of the prediction error computation period. However, in cases in which the statistical model coefficient estimation period is a low proportion of the prediction error computation period, the possibility arises that the determination section 128 mis-determines the person 10 as being present even if the person 10 is not included amongst the reflecting objects. For example, even if the pattern of operation or cycle of operation of a machine included amongst the reflecting objects changes, the prediction error becomes large when the statistical model coefficient estimation period is not provided after the change, and the possibility arises that the determination section 128 mis-determines the person 10 to be present.

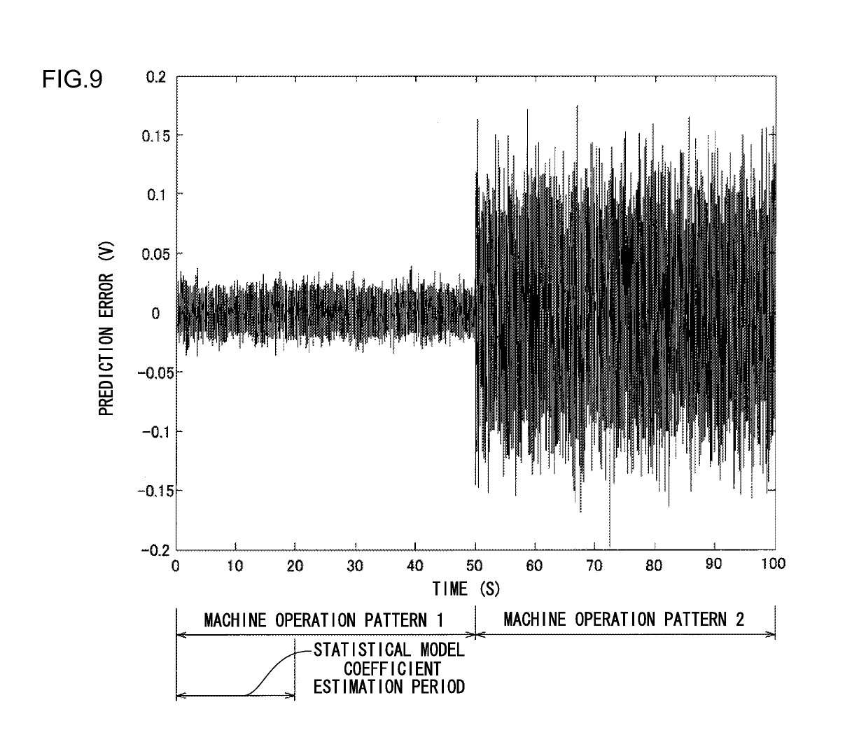

FIG. 9 is a graph illustrating a change in prediction error accompanying change in a pattern of operation of a periodically moving object. Say the statistical model estimation section 124 estimates the statistical model coefficients when the periodically moving object is operating in the operation pattern 1. When the machine then operates in an operation pattern 2 from time t₁ onward, even though the Doppler signal obtained by the Doppler radar 104 is still a periodic signal, the pattern of the waveform changes according to the change in the operation pattern. The prediction error is large when the statistical model expressing the operation pattern 1 is a poor fit to the operation pattern 2. There is accordingly a possibility that the determination section 128 mis-determines the person 10 to be present even if the person 10 is not actually present.

Configuration may accordingly be made such that the statistical model estimation section 124 re-estimates the statistical model when the degree of incompatibility of the statistical model exceeds a specific threshold value, and updates the statistical model. For example, the threshold value Thₑ may be considered exceeded in cases in which the degree of incompatibility of the statistical model exceeds the threshold value Thₑ even momentarily. Or, the threshold value Thₑ may be considered exceeded in cases in which the degree of incompatibility of the statistical model exceeds the threshold value Thₑ for a specific period of time or greater, after the statistical model coefficient has been updated the previous time. Alternatively, the threshold value Thₑ may be considered exceeded in cases in which the degree of incompatibility of the statistical model exceeds the threshold value Thₑ for a specific proportion or greater of a specific period of time after the statistical model coefficient has been updated the previous time.

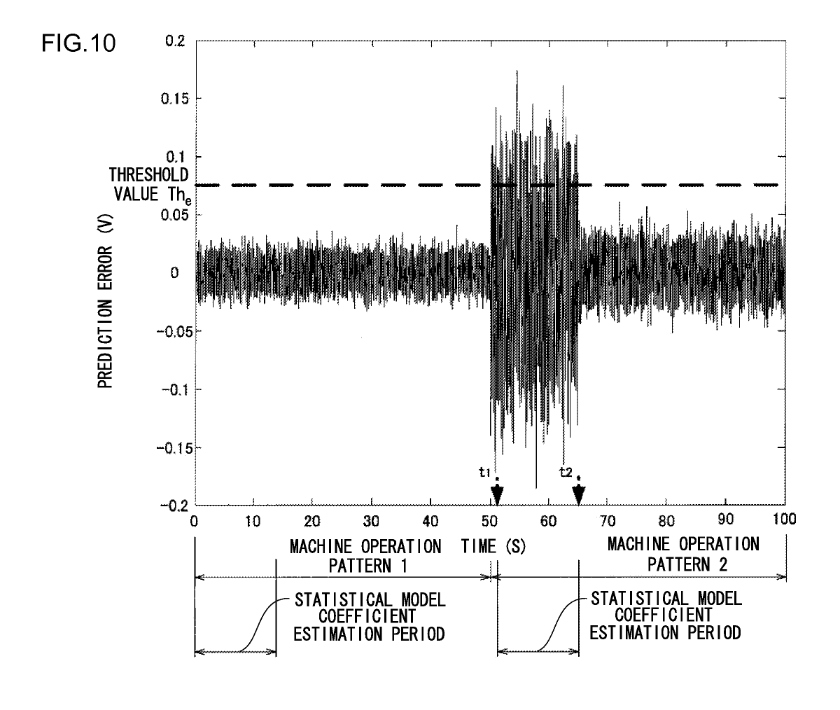

FIG. 10 is a graph illustrating change in prediction error accompanying change in an operation pattern of a periodically moving object for a case in which a statistical model coefficient estimation period is provided. As illustrated in FIG. 10, the statistical model estimation section 124 provides the statistical model coefficient estimation period from time t₁ to time t₂, prompted by the prediction error exceeding the threshold value Thₑ, wherein the threshold value Thₑ is the value of the variance of the prediction error. The prediction error exceeding the threshold value Thₑ arises in response to the change in operation of the periodically moving object from the operation pattern 1 to the operation pattern 2. In the statistical model coefficient estimation period, since the statistical model estimation section 124 estimates the statistical model coefficients according to the operation pattern 2 after the change, the prediction error falls back below the threshold value Thₑ after the statistical model estimation period.

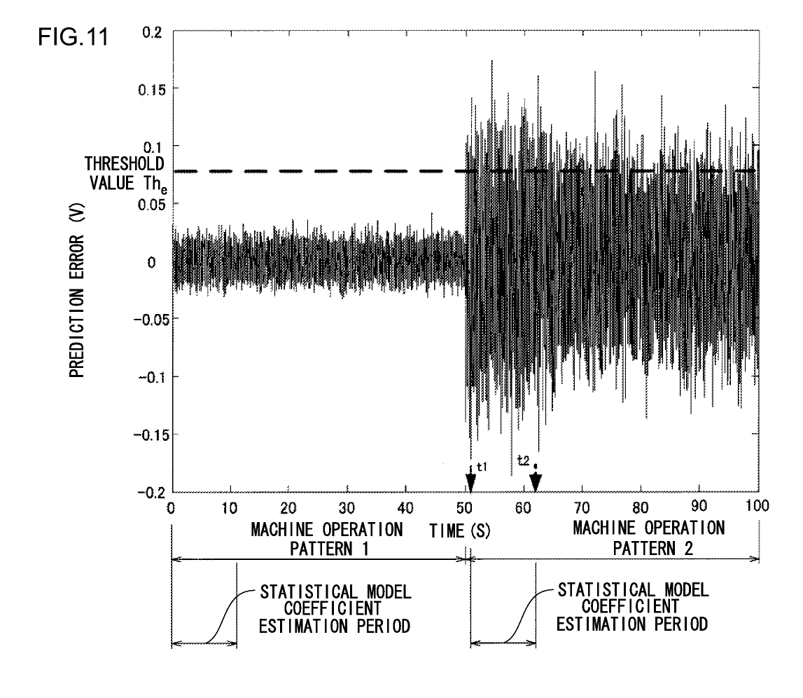

Thus, even in cases in which the waveform of the Doppler signal changes and the prediction error exceeds a threshold value due to change in the operation pattern of the periodically moving object, the statistical model estimation section 124 may take exceeding of the threshold value as a prompt to update the statistical model according to the operation pattern after the change. Therefore, the change in the operation pattern of the periodically moving object does not cause the determination section 128 to mis-determine the presence of the person 10. Explanation next follows regarding an example in which the waveform of the Doppler signal due to the person 10 changes, with reference to FIG. 11.

FIG. 11 is a graph illustrating change in prediction error accompanying entry of the person 10 for a case in which a statistical model coefficient estimation period is provided. As illustrated in FIG. 11, the statistical model coefficient estimation period is provided from time t₁ to time t₂, prompted by the prediction error exceeding the threshold value Thₑ, wherein the threshold value Thₑ is the value of the variance of the prediction error. However, the person 10 moves aperiodically, and so the Doppler signal is an aperiodic signal. The prediction error accordingly still exceeds the threshold value Thₑ even after the statistical model estimation section 124 has estimated the statistical model in the statistical model coefficient estimation period.

By thus providing the statistical model coefficient estimation period using the threshold value, the person 10 is not mis-determined as being present even though the operation cycle or the operation pattern of the periodically moving object changes. When the person 10 is present, the prediction error still exceeds the threshold value after the statistical model coefficient estimation period has elapsed, enabling determination that the person 10 is present.

In the above, the statistical model coefficient estimation period is provided prompted by the prediction error exceeding the threshold value Thₑ; however, the exemplary embodiment is not limited to this example. For example, a statistical model coefficient estimation period may be provided prompted by a statistical quantity computed from the prediction error, such as an average or standard deviation in a fixed period of time, exceeding a threshold value Thₑ. Or, the statistical model coefficient estimation period may be prompted at fixed intervals. Specifically, configuration may be made such that the statistical model estimation section 124 re-estimates the statistical model at specific intervals, and updates the statistical model.

3-3: Determination of Presence or Absence of a Person

Explanation has been given above regarding estimation processing of the statistical model on the assumption of a periodic signal. The determination section 128 then determines whether or not the person 10 is present amongst the reflecting objects based on the degree of incompatibility between the statistical model estimated by the statistical model estimation section 124, and time series fluctuations in the Doppler signal or the data obtained by performing specific data conversion on the Doppler signal. Explanation next follows regarding processing that determines whether or not the person 10 is present amongst the reflecting objects based on prediction using the statistical model estimated by the statistical model estimation section 124, and the degree of incompatibility of the statistical model.

At step S216, the determination section 128 computes from samples in observation periods the prediction error in a period of time similar to an observation period T, or an observation period T′ different from the observation period T, using the estimated statistical model.

At step S220, the determination section 128 computes the value of AIC from the computed prediction error, as the degree of incompatibility of the statistical model.

For example, AIC may be expressed by the following equation, wherein N is the number of samples, p is the order of the AR coefficients of an ARMA model, q is an order of a MA coefficient, and \tilde{σ}ₑ² is the variance of the prediction error.

AIC=N log(2π\hat{σ}ₑ²)+N+2(p+q+1) Equation 12

Then at step S224, the determination section 128 compares a predetermined threshold value Thₐ with the value of AIC. The determination section 128 then determines at step S228 that the person 10 is present if the value of AIC exceeds the threshold value Thₐ, and determines at step S232 that the person 10 is not present if the value of AIC is the threshold value Thₐ or lower. Then at step S236, the determination result display section 132 displays the result of step S228 or step S232. For example, the determination result display section 132 may display on a screen, or sound a warning.

The threshold value Thₐ may, for example, be considered exceeded in cases in which the degree of incompatibility of the statistical model exceeds the threshold value Thₐ even momentarily. Or, the threshold value Thₐ may be considered exceeded in cases in which the degree of incompatibility of the statistical model exceeds the threshold value Thₐ for a specific period of time or greater, after the statistical model has been updated the previous time. The threshold value Thₐ may also be considered exceeded in cases in which the degree of incompatibility of the statistical model exceeds the threshold value Thₐ for a specific proportion or greater of a specific period of time after the statistical model coefficient has been updated the previous time.

Effects

As explained above, the present exemplary embodiment is able to determine the presence or absence of the person 10 even in cases in which disturbance is present in the detection area of the Doppler signal. More specifically, in cases in which there is a periodically moving object present in the detection area, the determination section 128 is capable of determining the presence or absence of the person 10 without mis-determining such a periodically moving object as the person 10. Even in cases in which there is a change in the waveform of the Doppler signal due to a change in the operation pattern of the periodically moving object present in the detection area or the like, the determination section 128 is still able to determine the presence or absence of the person 10 without mis-determining such a periodically moving object as the person 10.

Thus, even in cases in which there is a periodically moving object that performs operations with a speed that resembles the action and activity of a person 10 in the detection area of the Doppler signal, the determination section 128 is able to discriminate between the person 10 and the periodically moving object. For example, the determination section 128 is able to detect the presence or absence of a person 10 even where there is disturbance due to movement of a machine, such as swinging of a fan or heater, a turntable of a microwave, or a washing machine. Even when there are plural periodically moving objects present, the statistical model estimation section 124 is still able to estimate a statistical model representing periodicity of time series fluctuations in a Doppler signal arising due to the plural periodically moving objects. Thus, even in such situations, the determination section 128 is still able to determine the presence or absence of the person 10 without mis-determining the periodically moving objects as the person 10. Moreover, even when the number of periodically moving objects in the detection area increases or decreases, the statistical model estimation section 124 is able re-estimate and update the statistical model in response to the increase or decrease. Thus, even in such situations, the determination section 128 is able to determine the presence or absence of the person 10 without mis-determining the periodically moving object as the person 10.

Other than when the degree of incompatibility of the statistical model exceeds a threshold value, the present exemplary embodiment is also able to estimate the statistical model at specific intervals and update the statistical model. The statistical model estimation section 124 is accordingly able to prevent deterioration in the reliability of the statistical model with the passage of time since the statistical model is estimated at the specific intervals irrespective of the magnitude of the degree of incompatibility of the statistical model.

The present exemplary embodiment is also capable of applying the above processing to unspecified frequency components due to not being limited to the frequency range of extracted components as in Fourier transformation.

The present exemplary embodiment is also capable of detecting the presence or absence of the person 10 based on the IQ signal, enabling the detection of periodicity based not only on patterns in speed fluctuation of the reflecting object, but also on patterns in movement toward or away from the Doppler radar 104. When a multivariate model is used, the presence or absence of the person 10 can be determined based on various data, in contrast to the Comparative Example in which determination of the presence or absence of the person 10 is made based on only the power spectrum.

### 4. CONCLUSION

Although detailed explanation has been given above of an exemplary embodiment, with reference to the appended drawings, the exemplary embodiment of the present invention is not limited to this example. It is clear that various modifications and improvements are obtainable by a person of ordinary skill in the art of the present invention, within the range of technical thought recited by the scope of the patent claims. Such modifications and improvements should obviously be understood to fall within the technical scope of the present invention.

For example, in the above exemplary embodiment, the statistical model estimation section 124 re-estimates the statistical model when the prediction error has exceeded a threshold value, and the determination section 128 determines the person 10 to be present when the AIC of the statistical model has exceeded a threshold value; however, the present invention is not limited to this example. For example, configuration may be made such that the statistical model estimation section 124 re-estimates the statistical model when the AIC has exceeded a threshold value, and the determination section 128 determines the presence of the person 10 when the prediction error of the statistical model has exceeded a threshold value. Namely, the degree of incompatibility of the statistical model may be the AIC of the statistical model or the prediction error, or may be another evaluation measure. Moreover, the prediction error, the AIC or any other evaluation measure may be commonly used for prompting estimation of the statistical model and prompting estimation of the presence or absence of the person 10.

In the above exemplary embodiment, the determination section 128 detects the presence or absence of the person 10 using the prediction error of an ARMA model; however, the exemplary embodiment is not limited to this example. For example, the determination section 128 may detect the presence or absence of the person 10 using another person detection method using a combination of prediction error of an ARMA model and Fourier transformation.

In the above exemplary embodiment, the determination section 128 determined the presence or absence of the person 10 based on threshold determination on AIC in a single given period of time; however, the exemplary embodiment is not limited to this example. For example, configuration may be made such that the presence or absence of the person 10 is determined based on threshold determination on other statistical quantity, such as an average value or variance value of the AIC in plural periods of time. Alternatively, a method may be applied of classifying the values of AIC and of a statistical quantity of AIC into those indicating person present states and person absent states, and adopting the state having closest Mahalanobis' distance to the AIC computed from the observed Doppler signal as a determination result, or a machine learning algorithm such as a support vector machine may be applied.

1. An object detection device comprising:
a statistical model estimation section that is configured, using a Doppler signal in a specific period of time for a given reflecting object, or using data obtained by performing a specific data conversion on the Doppler signal, to estimate a statistical model expressing time series fluctuations in the Doppler signal or in the data; and
a determination section that is configured to determine whether or not there is an aperiodically moving object present at the reflecting object based on incompatibility between the statistical model estimated by the statistical model estimation section and the time series fluctuations in the Doppler signal or in the data.

2. The object detection device of claim 1, wherein the determination section is configured to determine the presence of the aperiodically moving object at the reflecting object in a case in which a degree of incompatibility of the statistical model estimated by the statistical model estimation section exceeds a specific threshold value.

3. The object detection device of claim 1, wherein the statistical model estimation section is configured to re-estimate the statistical model and update the statistical model in a case in which the degree of incompatibility of the statistical model exceeds a specific threshold value.

4. The object detection device of claim 2, wherein the case in which the degree of incompatibility of the statistical model exceeds the specific threshold value comprises a case in which the degree of incompatibility of the statistical model exceeds the threshold value for a specific period of time or greater, or a case in which the degree of incompatibility of the statistical model exceeds the threshold value for a specific proportion or greater in a specific period of time.

5. The object detection device of claim 3, wherein the case in which the degree of incompatibility of the statistical model exceeds the specific threshold value comprises a case in which the degree of incompatibility of the statistical model exceeds the threshold value for a specific period of time or greater, or a case in which the degree of incompatibility of the statistical model exceeds the threshold value for a specific proportion or greater in a specific period of time.

6. The object detection device of claim 1, wherein the model estimation section is configured to estimate the statistical model and update the statistical model at specific intervals.

7. The object detection device of claim 1, wherein the statistical model estimation section is configured to estimate a coefficient contained in the statistical model.

8. The object detection device of claim 1, wherein the degree of incompatibility of the statistical model is a numerical value computed based on Akaike's information criterion (AIC) of the statistical model, or a difference between a predicted value of the statistical model and an actual value.

9. The object detection device of claim 1, wherein the statistical model is one of: an autoregressive model (AR model), an autoregressive moving average model (ARMA model), an autoregressive integrated moving average model (ARIMA), an autoregressive and moving average processes with exogenous regressors model (ARIMAX model), a vector autoregressive model (VAR model), a vector autoregressive moving average model (VARMA model), a vector autoregressive integrated moving average model (VARIMA model), or a vector autoregressive and moving average processes with exogenous regressors model (VARIMAX model).

10. The object detection device of claim 1, wherein the data obtained by performing the specific data conversion on the Doppler signal comprises an instantaneous amplitude, an instantaneous frequency, or an areal velocity computed from the Doppler signal.

11. The object detection device of claim 1, wherein the aperiodically moving object is a person.

12. An object detection method comprising:
using a Doppler signal in a specific period of time for a given reflecting object, or using data obtained by performing a specific data conversion on the Doppler signal, to estimate a statistical model expressing time series fluctuations in the Doppler signal or in the data; and
determining whether or not there is an aperiodically moving object present at the reflecting object based on incompatibility between the statistical model and time series fluctuations in the Doppler signal or in the data.

13. A non-transitory computer readable storage medium storing a program that causes a computer to execute object detection processing, the object detection processing comprising:
using a Doppler signal in a specific period of time for a given reflecting object, or using data obtained by performing a specific data conversion on the Doppler signal, to estimate a statistical model expressing time series fluctuations in the Doppler signal or in the data; and
determining whether or not there is an aperiodically moving object present at the reflecting object based on incompatibility between the statistical model and time series fluctuations in the Doppler signal or in the data.
